(19) United States
(12) Patent Application Publication
(10) Pub. No.: US 2007/0046620 A1
(43) Pub. Date: Mar. 1, 2007

(54) Light transmission device and light transmission system

(75) Inventor: Atsushi Ugajin, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/395,257

(22) Filed: Apr. 3, 2006

(30) Foreign Application Priority Data
Aug. 29, 2005 (JP) 2005-247840

(51) Int. Cl. G09G 3/36

(52) U.S. Cl. 345/104

(57) ABSTRACT

A light transmission device transmits an image signal on light to an output device based on a control signal for controlling the image signal. The light transmission device includes a transmitting interface component, a receiving interface component, and a light transmitting medium. The transmitting interface component converts the image signal to a light signal and transmits the light signal. The receiving interface component converts the light signal transmitted from the transmitting interface component to an image signal and transmits the same to the output device. The light transmitting medium connects the transmitting interface component and the receiving interface component. The transmitting interface component includes a combining component, which classifies the image signal to each of plural bit data channels according to a predetermined condition, inserts the control signal into the remaining bits of the bit data channels and then carries out modulation.

### CROSS-REFERENE TO RELATED APPLICATION

This application claims priority under 35USC 119 from Japanese Patent Application No. 2005-247840, the disclosure of which is incorporated by reference herein.

### BACKGROUND

1. Technical Field

The present invention relates to light transmission devices for light transmitting an image signal, generated at an image signal generating component to an output device, based on a control signal for controlling the image signal, and in particular to a light transmission device for connecting equipment or control boards by means of light transmission.

2. Related Art

Conventionally, when transmitting a graphic signal generated in a graphic signal (image signal) generating device to an output device such as a display device, the graphic signal is parallel to serial converted and transmitted in the form of an electric signal using an electric cable in the form of five channels in total, that is, three channels which are RED (hereinafter referred to as “R”), GREEN (hereinafter referred to as “G”) and BLUE (hereinafter referred to as “B”), one channel which is for a horizontal synchronization signal, a vertical synchronization signal, a data enable (valid) signal, and one channel for a frame clock signal.

FIG. 6 is a block diagram of a transmission system widely used in the related art, and includes a graphic signal generating device 100 and a graphic signal transmitting component 102 for the transmission side, and a graphic signal receiving component 104 and a display component 106 for the reception side.

The data is 6 bits/color, and the bit signal of each channel is converted to 7 bits/color by the graphic signal generating device 100. Hsync represents the horizontal synchronization signal and Vsync represents the vertical synchronization signal.

DE (Data Enable) is a data enable signal, and enabled data means the data synchronized during the assert period.

Parallel to serial conversion is performed in the graphic signal transmitting component 102, and serial to parallel conversion is performed in the graphic signal receiving component 104. Normally, copper cable 108 is used between the graphic signal transmitting component 102 and the graphic signal receiving component 104 for the transmission between substrates. Although it depends on the transmitting distance, in many cases, two copper cables (electric wires) are required for one channel in order to undertake transmission by the difference signal, and the cables are generally twisted.

Further, strengthening of the ground earth is undertaken in order to adjust the characteristic impedance and to suppress radiation noise. This is one of the reasons the structure of the cable itself becomes complicated in transmissions using copper cable.

The clock adopts a method (source synchronous method) of transmitting the clock to which the data is serialized as a frame clock parallel to the data (in which the graphic signal is serialized). Normally, transmission is often performed at a frequency that synchronizes the parallel data. This is because the frequency at the time of serialization is too fast to transmit at.

### SUMMARY

According to an aspect of the present invention, a light transmission device transmits an image signal on light to an output device, based on a control signal for controlling the image signal. The light transmission device includes: a transmitting interface component that converts the image signal to a light signal and transmits the light signal; a receiving interface component that converts the light signal transmitted from the transmitting interface component to an image signal and transmits the image signal to the output device; and a light transmitting medium that connects the transmitting interface component and the receiving interface component. In the light transmission device, the transmitting interface component includes a combining component, and the combining component classifies the image signal for each of plural bit data channels according to a predetermined condition, inserts the control signal into the remaining bits of the bit data channels and then performs modulation.

### BRIEF DESCRIPTION OF THE DRAWINGS

Exemplary embodiments of the present invention will be described in detail based on the following figures, wherein:

FIG. 1 is a schematic configuration diagram of an image display system applied with a light transmission device according to an exemplary embodiment of the present invention;

FIG. 2 is a control block diagram showing in detail the light transmission device according to the exemplary embodiment of the present invention;

FIG. 3 is a conceptual diagram showing the state of conversion of the bit data;

FIG. 4 is a control block diagram showing in detail the light transmission device according to a first exemplary modification;

FIG. 5 is a control block diagram showing in detail the light transmission device according to a second exemplary modification; and

FIG. 6 is a control block diagram of a signal transmitting device according to the related art.

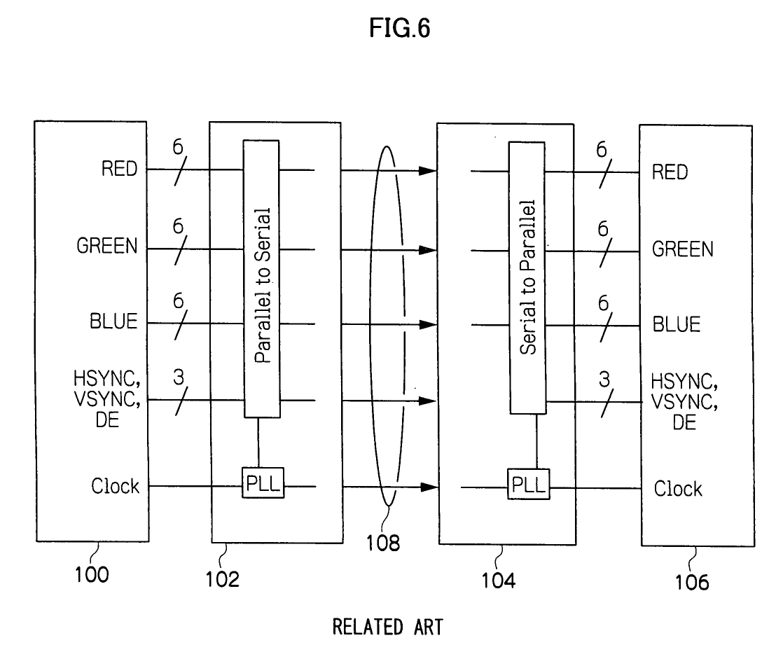

### DETAILED DESCRIPTION

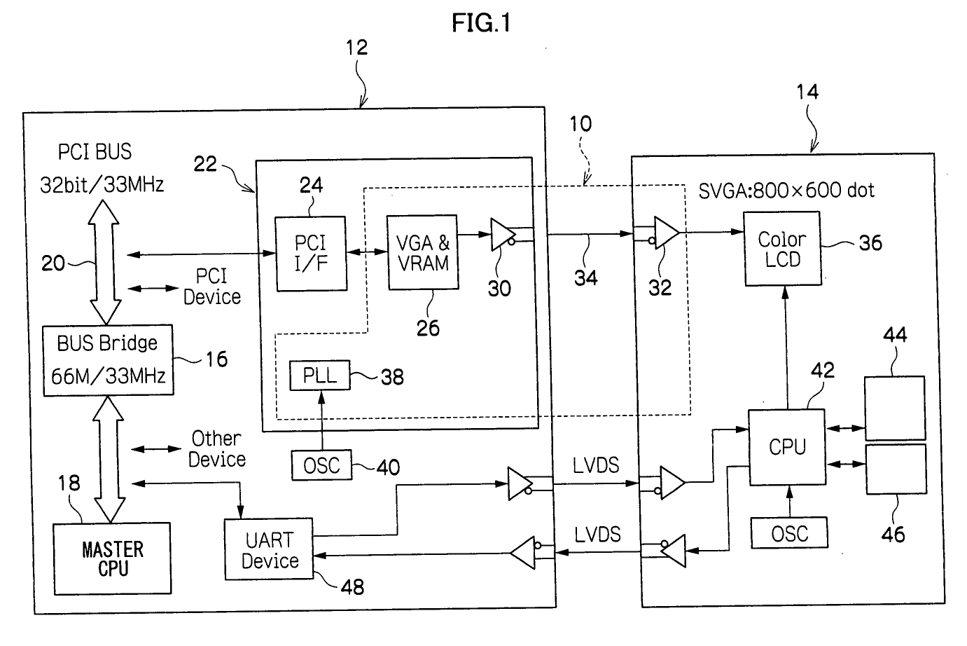

FIG. 1 is a block diagram showing the relationship between a main device 12 and a user interface 14 in an image display system applied with the light transmission device 10 according to an exemplary embodiment of the present invention.

A bus bridge 16 is arranged in the main device 12. The bus bridge 16 is controlled by a master CPU 18 and performs signal transmission and reception with the outside via a PCI BUS 20.

An image data managing section 22 for managing the image data (graphic signal) is arranged in the main device 12. The image data managing section 22 includes a PCI/IF 24 that is in connection with the PCI BUS 20.

The PCI/IF 24 retrieves the image data with the control of the master CPU 18 and stores it in the VGA&VRAM 26. The data stored in the VGA&VRAM 26 is the graphic signal.

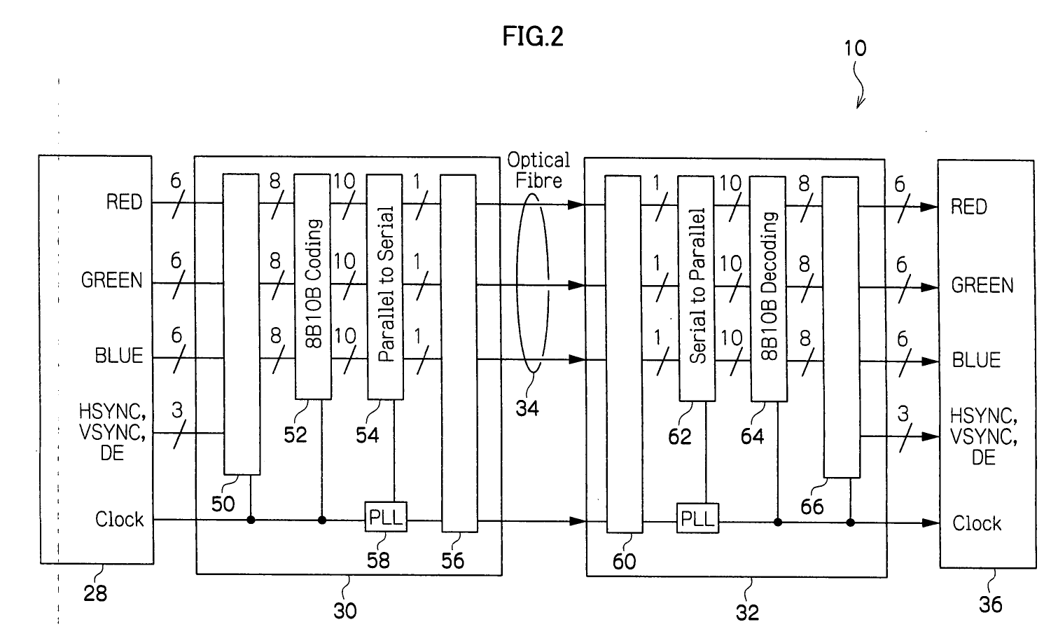

The VGA&VRAM 26 is configured including a graphic signal generating device 28 (refer to FIG. 2). In the VGA&VRAM 26, the horizontal synchronous signal, the vertical synchronous signal, and the data enable signal (generically named control signal) are managed. The signals are then sent to the transmitting interface section 30 with the graphic signal.

The transmitting interface section 30 is connected to the receiving interface section 32 of the user interface 14 by way of the optical fiber 34 acting as the light transmitting medium.

In the receiving interface section 32, the image is displayed on the LCD 36 serving as the output device (display device) based on the light signal transmitted from the transmitting interface section 30.

The light transmission device 10 (refer to FIG. 2) is configured by the VGA&VRAM 26 (graphic signal generating device 28), the transmitting interface section 30, and the receiving interface section 32. A clock generating PLL (Phase Locked Loop) 38 is arranged in the light transmission device 10, generating the clock signal of N times the fundamental frequency signal from the oscillator (OSC) 40 (described later).

The LCD 36 is display controlled by the CPU 42 and is synchronized with a touch panel 44 and a ten key 46. By performing touch operation or ten key operation while looking at the screen displayed on the LCD 36, the signal corresponding to the relevant operation is sent from the CPU 42 to the UART device 48 on the main device 12 side (the transmission and reception signal are conventional electric signals (LVDS)). The operation signal is then analyzed in the master CPU 18 and the execution is instructed.

FIG. 2 is a block diagram showing in detail the light transmission device 10 according to the exemplary embodiment.

The light transmission device 10 includes, as the transmission side of the overall schematic configuration, the graphic signal generating device 28 and the transmitting interface section 30. It further includes the receiving interface section 32 and the display device (LCD) 36, for the reception side.

The three channels of graphic signal and one channel of control signal are generated in the graphic signal generating device 28.

The graphic signal (6 bits/color) and the control signal (3 bits) are sent from the graphic signal generating device 28 to the transmitting interface section 30.

In a bit combining part 50 of the transmitting interface section 30, the 3 bits of control signal is allocated to each channel of the graphic signal, and 1 dummy bit is combined with the relevant graphic signal. For instance, RED is 6 bits+Hsync 1 bit+dummy bit=8 bits. The 8 bits of data is sent to the 8B10B coding part 52.

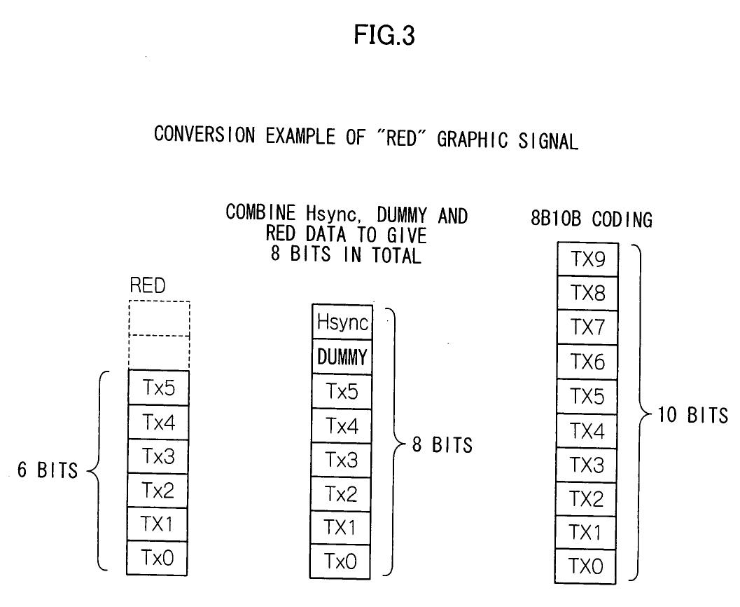

The 8B10B modulating (coding) part 52 is a well known modulation coding component that performs modulation coding to maintain the DC balance of the bit data (refer to FIG. 3).

The data modulation coded to 10 bits is converted to serial data by the parallel to serial (P/S) converting part 54, and is then sent to the optical connector transmitting part 56, so that the serial data is electrical-light converted.

The serial data is generated in serial conversion at a clock speed made 10 times that of the clock synchronized with the parallel data in the PLL (Phase Locked Loop) 58.

The optical connector transmitting part 56 includes an LED serving as a light source and is connected with one end of the optical fiber 34 serving as the light transmitting medium for transmitting the emitted light of the LED to the receiving interface section 32.

The modulation coding will now be briefly explained.

Transmission coding that includes a direct current component is not suitable for properly reproducing a signal so as to cover cases when the attenuation amount of the signal in the transmission line changes greatly.

This is because the threshold value for determining “1” or “0” needs to be changed according to the attenuation amount of the received signal, and the number of changes required for timing reproduction (clock reproduction) on the reception side changes greatly, and the timing design becomes more difficult.

That is, if the data pattern in which the graphic signal is serialized is transmitted as it is, it may not be properly reproduced on the reception side since the direct current component changes.

Thus, conversion to a code (code in which the proportion for generation of 1 and 0 is the same) having direct current (DC) balance which does not depend on the data and the pattern is thus required.

The 8B10B coding technique generally used in essential communication is widely used for such technique. The 8B10B modulation coding is applied in this exemplary embodiment.

The light signal electric-light converted in the optical connector transmitting part 56 is transmitted to the optical connector receiving part 60 of the receiving interface section 32 via the optical fiber 34.

In the optical connector receiving part 60, the light signal is converted to an electric signal (light-electric conversion). The serial to parallel (S/P) converting part 62 is connected in the optical connector receiving part 60, and the electric signal is converted to parallel data in the serial to parallel (S/P) converting part 62.

The serial to parallel (S/P) converting part 62 is connected to the 8B10B demodulating (decoding) part 64, and the 10 bit signals are decoded to 8 bit signals. A bit allocating part 66 is arranged at the final stage of the receiving interface section 32, wherein the combined bit data (8 bits×three channels of parallel data (24 bits)) is allocated to the graphic signal (6 bits×3 colors) and the control signal (3 bits).

Each allocated data (graphic signal and control signal) is sent to the display device (LCD) 36.

The operation of the exemplary embodiment will now be explained.

Three channels of graphic signal and one channel of control signal are generated in the graphic signal generating device 28. The graphic signal is 6 bits/color and the control signal is 3 bits.

The above bit data is sent to the bit combining part 50 of the transmitting interface section 30.

In the bit combining part 50, the three bits of control signal are allocated to each channel of the graphic signal, and further, 1 dummy bit is combined with the graphic signal. As a result, the bit data of each color becomes 8 bits.

The 8 bits of data is modulated to 10 bits of data in the 8B10B coding part 52, and as a result, the DC balance during transmission is maintained.

FIG. 3 shows a case of inserting the horizontal synchronous signal to the RED by way of example to show the insertion of the horizontal synchronous signal, the vertical synchronous signal, and the data enable signal, each to the remaining bit in the graphic signal. This is the same for GREEN and BLUE. In this exemplary embodiment, since the control signal is 3 bits, 1 bit thereof is combined with each color channel, and 1 dummy bit is further combined. By consequently having 8 bits of data, 8B10B coding becomes possible, and thus even if there is an increase or decrease in the control signal or an increase or decrease in the number of bits of the color data, by increasing or decreasing the number of dummy bits by the same amount this can be accommodated to a certain degree.

The data modulation coded to 10 bits is converted to serial data by the parallel to serial (P/S) converting part 54, and sent to the optical connector transmitting part 56, where the serial data is electric-light converted. Here, the serial data is generated at a clock speed made 10 times that of the clock synchronized with the parallel data in the PLL (Phase Locked Loop) 58.

In the optical connector transmitting part 56, the 10 bits of serial data (three colors) and the clock signal are electric-light converted and transmitted to the optical connector receiving part 60 of the receiving interface section 32 by the optical fiber 34 as a light signal.

In the optical connector receiving part 60, the light signal is converted to an electric signal (light-electric conversion), and then converted to parallel data in the serial to parallel (S/P) converting part 62.

The 10 bits of signal that is parallel converted is decoded to 8 bits of signal in the 8B10B demodulation (decoding) part 64, and allocated to the graphic signal (6 bits×3 colors) and the control signal (3 bits) in the bit allocating part 66.

Each allocated data (graphic signal and control signal) is sent to the display device 36.

In the exemplary embodiment explained above, the configuration in which the graphic signal is transmitted through light transmission using the optical fiber 34 is provided, and further, the remaining bits from the bit data expressing the color signal are utilized, the bit data corresponding to the control signal is combined, thereby reducing the transmission line and at the same time the DC balance is maintained by the 8B10B coding and decoding. Thus, good transmission quality at high speed is obtained and the radiation noise is reduced while suppressing the cost with a simple configuration.

An image that accurately represents the graphic signal generated in the graphic signal generating device 28 can be displayed on the display device 36.

(Applicability of Display Device 36)

The display device 36 can be used, for instance, with SVGA (Super Video Graphics Array), one of the standard modes normally used for the display screen of a personal computer and the like.

The SVGA systems include modes of 800×600 dots, 1024×768 dots, and 1280×1024 dots resolution.

The SVGA system is widely used in machine operation screens such as control panels used in copying machines, printers and the like. The buttons and pictures for machine operation are displayed on the screen display, but no practical problem arises with the resolution of 800×600 dots. If a finer display is desired, the resolution is further fine to increase the displayable colors.

Since in this case the circuit configuration becomes complicated, such as increasing the memory capacity, increasing data speed and the like, it becomes a question of determining the balance between the requirement specification and the manufacturing cost. With regards to the transmission speed of the graphic signal when the resolution is 800×600 dots, the graphic signal is generated in synchronized at about 40 MHz and transmitted with the refresh rate of the screen at 75 Hz. That is, the graphic signal is about 40 Mbps.

(Usability of LEDs)

The transmission speed of the serial signal output from the parallel to serial (P/S) converting part 54 at the transmitting interface section 30 in FIG. 2 becomes 400 Mbps, since it is generated at 10 times the clock speed, as mentioned above.

A light source suitable to this transmission speed is necessary in the optical connector transmission part 56. Light sources generally used for light transmission include semiconductor lasers, an surface light emitting lasers and the like, but application is for high transmission speed bands of greater than a few Gbps. Thus, the manufacturing cost becomes expensive and the circuit configuration becomes complicated.

In the current technology, the performance of light emitting diodes (LEDs) has increased to about 500 Mbps, and the manufacturing cost is suppressed low when compared to semiconductor lasers since it is similar to the related art and the existing manufacturing facilities can be substantially used.

In other words, LEDs are suitable for transmitting at 400 Mbps. Since LEDs have a large angle of spread of the light source, the selection of POF (Plastic Optical Fiber) having a large core diameter is suitable for the transmitting medium. POF has a low manufacturing cost and is easy to handle.

(First Modification)

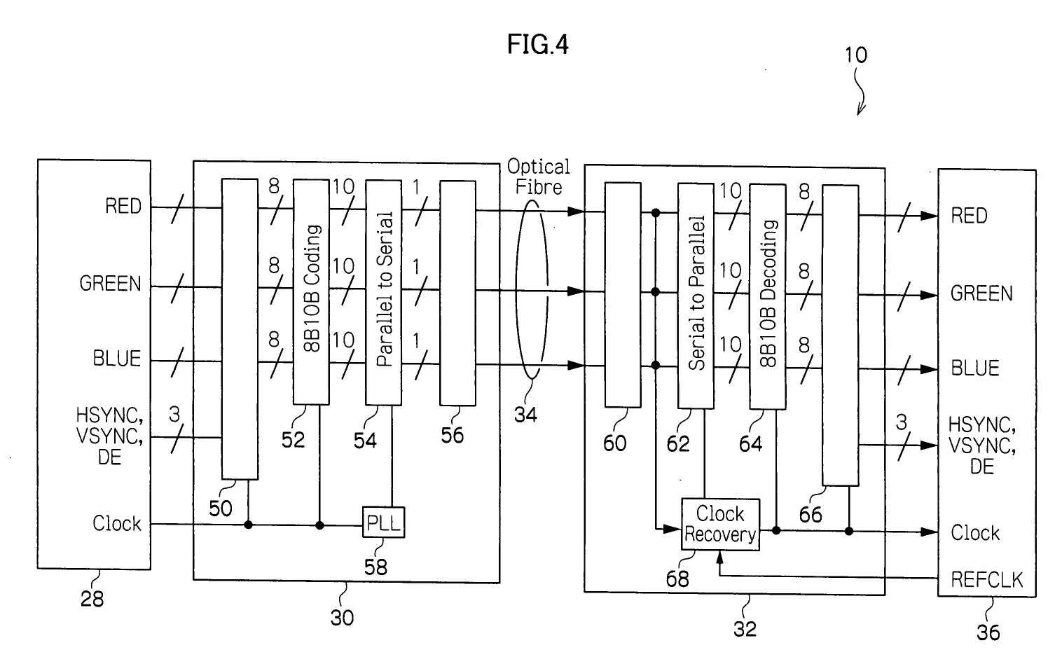

FIG. 4 shows a first modification of the exemplary embodiment (refer to FIG. 2).

This differs from the above exemplary embodiment (refer to FIG. 2) in that the frame clock is not transmitted. It is characterized in that it adopts a method of generating the clock by the data transmitted on the reception side by the clock recovery part 68 instead of transmitting the frame clock. Thus, the total number of transmitting media is reduced.

(Second Modification)

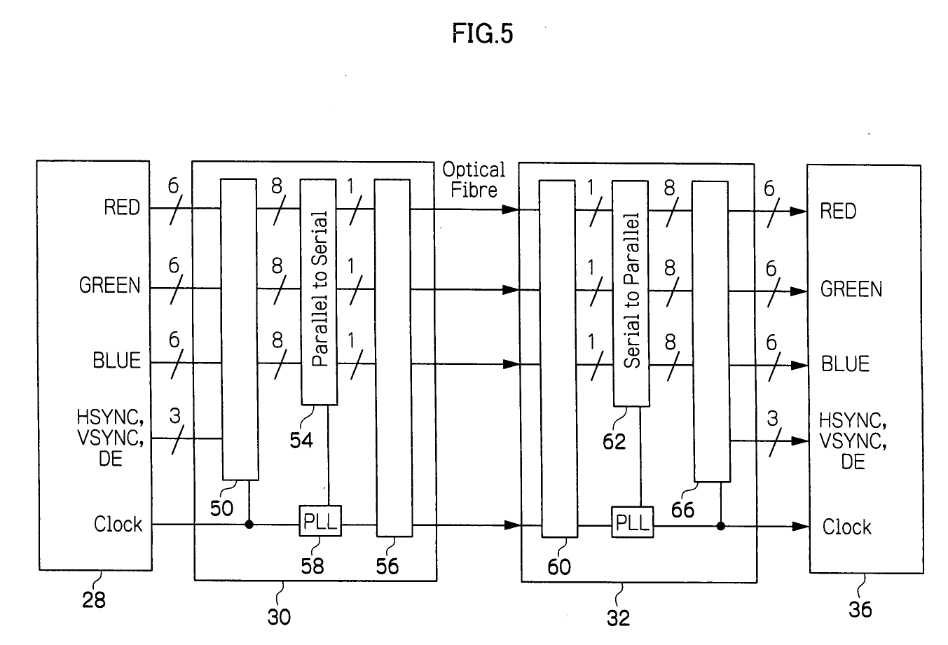

FIG. 5 shows a second modification of the exemplary embodiment.

The data inputs 6 bits/color and 3 bits of control signal to the transmitting interface section. Any 1 bit of the control signal and the dummy bit (1 bit) are combined with the 6 bits/color to become 8 bits in total. For instance, RED (6 bits)+Hsync (1 bit)+dummy bit (1 bit)=8 bits.

Similarly, GREEN (6 bits)+Vsync (1 bit)+dummy bit (1 bit) and BLUE (6 bits)+DE (1 bit)+dummy bit (1 bit).

Transmission coding that includes a direct current component is not suitable for properly reproducing a signal to cover cases when the attenuation amount of the signal in the transmission line changes greatly, as mentioned above. That is, the direct current component becomes high when the data is continuous at a fixed bit.

The 1 bit of the control signal inserted into the remaining bits changes with a constant period during operation. Hsync is a horizontal synchronous signal and thus changes once for every 800 pixels in a screen of 800×600 dots. Vsync is a vertical synchronous signal and thus changes once for every one screen (800×600=480000 pixels). DE (Data Enable) is a data enabling signal and thus changes once for every 800 pixels.

Therefore, the signal can be properly received with a circuit that can have DC balance on the reception side even if one signal changes occurs for a maximum length of 480000 pixels. As a result, the 8B10B modulating part 52 and the 8B10B demodulating part 64 shown in FIG. 2 and FIG. 4 can be omitted.

In the above exemplary embodiment and first and second modifications thereof, a transmission line is provided for each color of RED, GREEN, and BLUE, but clearly can be applied to a different color space, such as, when transmitting in the color signal of YMCK and the like or L*a*b* and the like.

The present invention is not limited to the above-described exemplary embodiments, and obviously suitable modifications can be applied within a scope which does not depart from the spirit of the present invention.

What is claimed is:

1. A light transmission device that transmits an image signal on light to an output device, based on a control signal for controlling the image signal, the light transmission device comprising:
a transmitting interface component that converts the image signal to a light signal and transmits the light signal;
a receiving interface component that converts the light signal transmitted from the transmitting interface component to an image signal and transmits the image signal to the output device; and
a light transmitting medium that connects the transmitting interface component and the receiving interface component; wherein
the transmitting interface component includes a combining component, and
the combining component classifies the image signal for each of a plurality of bit data channels according to a predetermined condition, inserts the control signal into the remaining bits of the bit data channels and then performs modulation.

2. The light transmission device of claim 1, wherein the transmitting interface component further includes a modulation coding component that carries out modulation coding subjecting each one of the bit data channels to DC balancing on the signal modulated by the combining component.

3. The light transmission device of claim 1, wherein a light source of the light signal transmitted by the transmitting interface component is an LED.

4. A light transmission device that transmits an image signal, composed of a plurality of color signals, generated at an image signal generating component on light to an output component, the light transmission device comprising:
a transmitting interface component that forms a transmission path for each of the plurality of color signals, inserts a control signal including at least a horizontal synchronization signal, a vertical synchronization signal, and a data enable signal into the remaining bits of channels of the plurality of color signals, then modulates the respective signals to a light signal and transmits the light signal as a transmitting signal;
a light transmitting medium that transmits the modulated transmitting signal; and
a receiving interface component that demodulates the transmitting signal transmitted from the light transmitting medium to each of an original image signal and a control signal and transmits the demodulated signal to the output component.

5. The light transmission device of claim 4, wherein the transmitting interface component includes:
a combining component that combines the image signal and the control signal as one transmitting signal;
a modulation coding component that carries out DC balancing so that the transmitting signal is suitable for the light transmitting medium;
a parallel to serial converting component that converts the transmitting signal, modulation coded by the modulation coding component, from parallel to serial;
a light transmission component that converts the serialized transmitting signal to a light signal and transmits the light signal to the light transmitting medium, and
the receiving interface component includes:
a light receiving component that converts the serialized transmitting signal transmitted from the light transmitting medium to an electrical image signal;
a serial to parallel converting component that converts the electrical serial transmitting signal from serial to parallel;
a demodulating component that demodulates the paralleled transmitting signal; and
an extracting component that extracts the image signal and the control signal from the demodulated transmitting signal.

6. The light transmission device of claim 5, further comprising a clock signal transmission component that, when the transmitting interface component converts the image signal to the electrical serial transmitting signal and further converts the serialized transmitting signal to the light signal and the light signal is transmitted via the light transmitting medium, the clock signal transmission component converts a clock signal which is used for generating the electric serial transmitting signal, or a clock signal generated by frequency dividing the clock signal, to a light signal as a frame clock and transmits the light signal from the transmitting interface component,
wherein the receiving interface component converts the frame clock transmitted from the light transmitting medium to an electrical signal and applies the frame clock as a clock when converting the transmitted serialized image signal to a parallel signal.

7. The light transmission device of claim 5, wherein, when the transmitting interface component converts the image signal to the electrical serial transmitting signal and further converts the serialized transmitting signal to the light signal and the light signal is transmitted via the light transmitting medium, a clock for serial to parallel conversion is generated based on the serialized transmitting signal via the light transmitting medium.

8. The light transmission device of claim 4, wherein the light source of the light signal sent from the transmitting interface component is an LED.

9. A light transmission device that transmits an image signal on light to an output device based on a control signal for controlling the image signal, the light transmission device comprising:
a transmitting interface component that converts the image signal to a light signal and transmits the light signal, the transmitting interface component including a combining component that classifies the image signal for each of a plurality of bit data channels according to a predetermined condition, inserts the control signal into the remaining bits of the bit data channels and then carries out modulation.

10. The light transmission device of claim 9, wherein the transmitting interface component further includes a modulation coding component that carries out modulation coding subjecting each one of the bit data channels to DC balancing on the signal modulated by the combining component.

11. A light transmission system comprising:
an image signal generating component that generates an image signal and a control signal for controlling the image signal;
a transmitting interface component that converts the image signal to a light signal and transmits the light signal;
a receiving interface component that converts the light signal transmitted from the transmitting interface component to an image signal;
an output device that outputs an image based on the image signal transmitted from the receiving interface component; and
a light transmitting medium that connects the transmitting interface component and the receiving interface component, wherein
the transmitting interface component includes a combining component that classifies the image signal for each of a plurality of bit data channels according to a predetermined condition, inserts the control signal into the remaining bits of the bit data channels and then carries out modulation.
